(19) United States
(12) Patent Application Publication
(10) Pub. No.: US 2014/0237538 A1
(43) Pub. Date: Aug. 21, 2014

(54) Input prediction in a database access control system

(71) Applicant: INTERNATIONAL BUSINESS MACHINES CORPORATION, Armonk, NY (US)

(72) Inventor: Leonid Rodniansky, Allston, MA (US)

(73) Assignee: INTERNATIONAL BUSINESS MACHINES CORPORATION, Armonk, NY (US)

(21) Appl. No.: 13/773,154

(22) Filed: Feb. 21, 2013

(51) Int. Cl. H04L 29/06

(52) U.S. Cl. CPC H04L 63/20; H04L 63/10
USPC 726/1

(57) ABSTRACT

A local database access control system (LDACS) intelligently determines which database access requests intercepted by a database agent requires analysis by an external security device and which of those requests might be predicted not to require such processing e.g., because they do not contain database object information that needs to be validated against a security policy. Client requests that are predicted not to require such processing are then passed to the database server directly without being held by the agent and delivered externally for policy validation. In this approach, the agent does not send every intercepted request to the security device for evaluation against the one or more security policies. Rather, only those intercepted requests that are predicted to contain database object information are delivered. The security device implements an input prediction scheme to facilitate this process by sending control commands to the agent.

### BACKGROUND OF THE INVENTION

1. Technical Field

This disclosure relates generally to securing resources in a distributed computing environment and, in particular, to database access security.

2. Background of the Related Art

It is known in the prior art to protect a database using network-based intrusion detection. Systems of this type analyze database access attempts prior to transport into a host computer system and accordingly, mitigate resource overhead. Host computer systems, however, often employ local access, such as a DBA account. Because monitoring access attempts via the network monitor may not encompass such local access attempts, it is also known in the art to provide a data security device that intercepts both local and remote access attempts to the database. This data security device monitors all database access attempts for auditing and security analysis. In operation, the data security device receives local access transactions via a local agent on the host. Typically, the local agent identifies and integrates with an interprocess communication (IPC) mechanism on the host computer system. Using an IPC interception mechanism (or, in an alternative, cryptographic method invocation or the like), the local agent directs local database access attempts to the local agent, which then forwards the intercepted attempts to the data security device for further analysis. The data security device is remote from the database host and thus is sometimes referred to as an “external security device” (or “ESD”). The ESD observes local access attempts via interception and transmission to the device, thereby consolidating analysis and logging of the data access attempts. A commercial product that provides this local database access control system (LDACS) functionality is IBM® InfoSphere® Guardium®.

While LCACS processing provides significant advantages, the agent intercepts all requests sent between database clients and the database server on IPC (which is not secured) or other secure access (e.g., cryptographic method invocation), and forwards all such intercepted requests to the data security device. Those requests are forwarded through the network to the ESD. The agent holds each database client request and waits for a decision (a verdict) from the ESD regarding whether to release the request to the database. Of course, the delivery of the intercepted requests over the network and the attendant hold time that is incurred (which includes the time needed to process the request at the data security device) slows down the database client application. This is a disadvantage, and in the case of relatively high rate database traffic, it can reduce significantly the feasibility of the LDACS scheme.

### BRIEF SUMMARY

The techniques herein increase LDACS throughput considerably by intelligently determining which database access requests intercepted by the agent require external analysis (by the ESD) and which of those requests might be predicted not to require such processing, e.g., because they do not contain (or are not expected to contain) database object information that needs to be validated against a security policy. Client requests that are predicted not to require such processing can then be passed to the database server directly without being held by the agent (and delivered to the ESD for processing). In this approach, the agent does not send every intercepted request to the ESD for evaluation against the one or more security policies. Rather, only those intercepted requests that contain (i.e., having been predicted to contain) database object information (or that otherwise should be validated against the one or more policies) are delivered to the ESD by the agent.

Preferably, the determination about whether a particular database access request should be held or passed by the agent is made using an input prediction scheme executed at (or in association with) the ESD. In a preferred approach, and upon receipt from the agent of a request for evaluation (that will generate a verdict from the ESD), the ESD performs its usual processing but also determines (i.e. predicts) whether a next database client request (or group of requests) anticipated to be received by the agent is likely to contain (or not contain) database object information, such as a database object name. This prediction may be based on one or more factors, such as the type of request currently being evaluated, one or more attributes of that request, one or more prior requests, other heuristics or statistics, or the like. If the ESD (in processing the current request) predicts that the next database client request (or group of requests) will include such information (and thus not need by sent to the ESD for evaluation), it returns an indication to this effect to the agent. This indication may be provided in one of many ways, e.g., as an adjunct to the verdict that is being returned in the normal manner, as a separate out-of-band communication, or the like. When the agent receives this notification, it is then applied when the next database access request(s) are then actually received (at the agent). In particular, given the ESD prediction that the next database access request(s) need not be validated against the one or more security policies, the next database access request(s) are passed through to the database server immediately and without being held by the agent.

The foregoing has outlined some of the more pertinent features of the disclosed subject matter. These features should be construed to be merely illustrative. Many other beneficial results can be attained by applying the disclosed subject matter in a different manner or by modifying the subject matter, as will be described below.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 depicts the high level operation of a known Local Database Access Control System (LDACS);

FIG. 4 is a process flow diagram illustrating the known operation of the LDACS of FIG. 3;

FIG. 5 depicts an LDACS that has been enhanced according to the techniques of this disclosure;

FIG. 6 illustrates a database client-server interaction; and

FIG. 7 illustrates how the database client-server interaction of FIG. 6 is processed by the LDACS agent and the ESD by using the input prediction techniques of this disclosure.

### DETAILED DESCRIPTION OF AN ILLUSTRATIVE EMBODIMENT

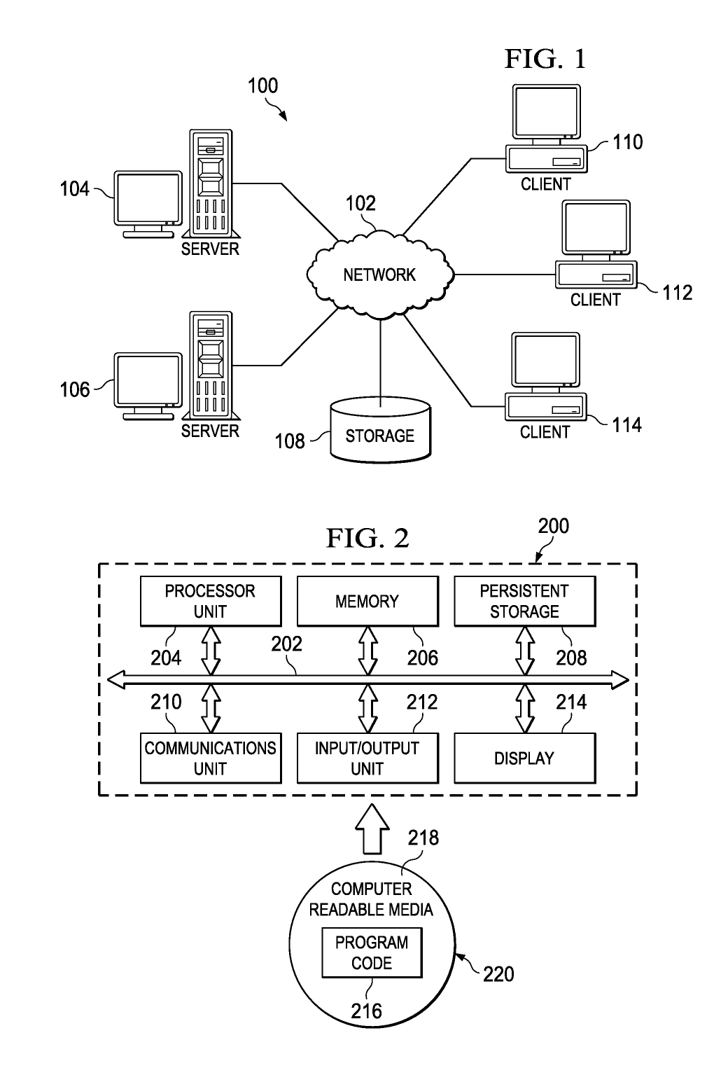

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the symmetric multi-processing (SMP) system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

In a representative but non-limiting implementation, the techniques herein are described in the context of a transaction-processing system or environment that comprises distributed and mainframe components, working cooperatively to respond to HTTP and Web Service client end-user service or transaction requests. Such a system or environment typically comprises multiple components, configured in a distributed manner. A distributed component of a larger multi-component transaction-processing environment typically comprises at least a computer, operating system platform, applications, networking and an associated security engine that provides distributed transaction processing functions, such as networking interactions with the client end-user, and identification and authentication functions in HTTP and Web Services scenarios. The transaction-processing system or environment of this type typically also includes a mainframe component that includes at least a computer, operating system platform, applications, networking and associated security engine that provides high performance back-end transaction processing and large database functionality.

### Local Database Access Control

Auditing and logging operations, as well as highly security-sensitive applications, expect coverage of all local and remote access attempts. To this end, and as described above, it is known in the prior art to enhance conventional network-based intrusion detection and monitoring by intercepting local access attempts in addition to the database access attempts occurring via the network. A Local Database Access Control System (LDACS) provides this functionality. In this approach, typically an IPC intercept is defined to identify an access point common to local and remote DB access attempts. Local access attempts to the database are intercepted and transported to a data security device operable for network monitoring of the access attempts. Because the data security device is remote, it is sometimes referred to herein as an “external security device” (or “ESD”). The IPC intercept performs interception of the local access attempts through a minimal footprint implementation object to mitigate resource overhead. In this manner, the remote network data security device observes both the local access attempts via interception at the DB host and transmission of the intercepted access attempts to the data security device, and the remote access attempts via the network, thereby consolidating analysis and logging of the data access attempts to the database resource via the data security device.

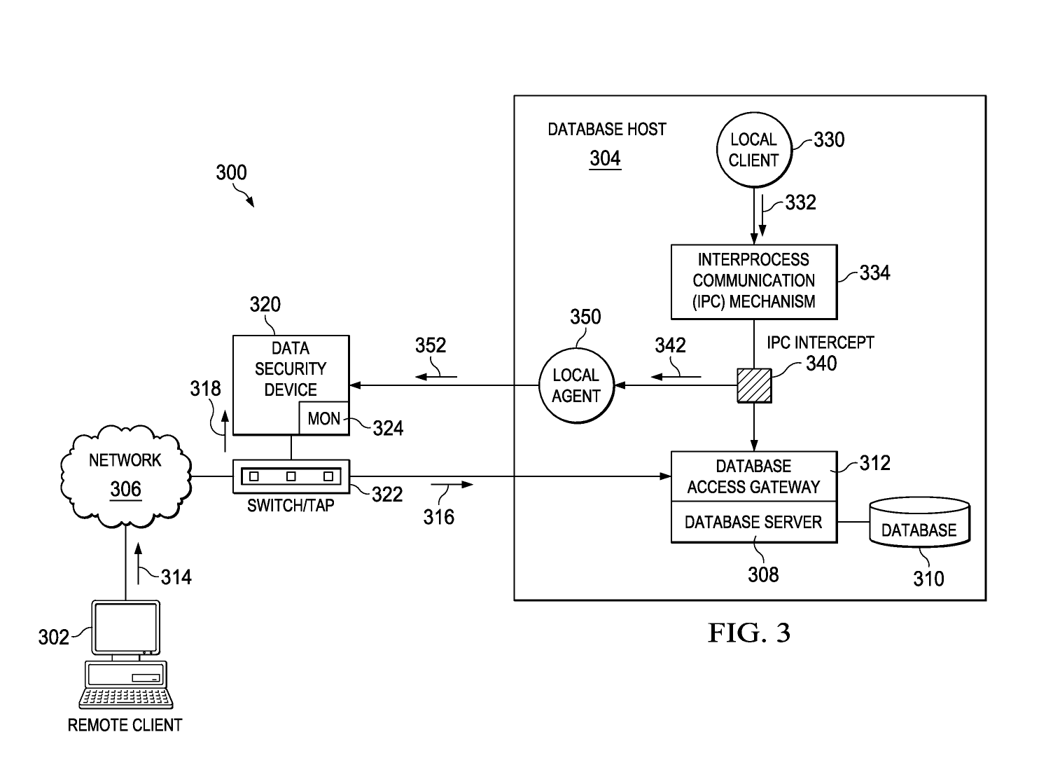

FIG. 3 illustrates this basic operation in more detail. Referring to FIG. 3, the environment 300 provides a remote user 302 with a database (DB) host 304 for data storage and retrieval operations (DB operations). The user 302 connects to the host 304 via an access network 306, which may be any suitable internetworking infrastructure such as a LAN, intranet, extranet or the Internet. The DB host 304 includes a database server 308 connected to the database 310, typically a disk array or set of mass storage devices such as disk drives. The database 308 includes a DB access gateway 312, which operates as an application programming interface (API) for user 302 access via a variety of access methods.

A user initiates access to the database in the form of a user request 314, which passes through the network 306 for delivery to the DB access gateway 312 as an incoming request 316. A data security device 320 is connected via a switch e22 or other connectivity device such as a tap, router or bridge, on the path from the network 306 to the host 304. The data security device 320 includes a DB monitor 324 for receiving user requests 314 sent through the switch 322. The DB monitor receives and analyzes the incoming user request 314 as a tapped access attempt 318, which the DB monitor 324 analyzes according to a predetermined security or access policy. The data security device 320 then passes the tapped access attempt 318 to the access gateway (AG) 312 as an incoming request 116.

Typically, the database server 308 expects a substantial portion of DB traffic (user requests 314) to arrive remotely via the network 306, and thus pass scrutiny under the data security device 320. However, a portion of database access attempts emanate locally from a local client 330, executing on the host 304, as local access attempts 332. The local access attempts 332 arrive at the access gateway 312 via an Inter-Process Communication (IPC) mechanism 334. Such local access attempts 332 do not pass through the switch 322, and therefore may otherwise be operable to elude scrutiny of the data security device 320. To address this concern, a known LDACS solution employs an IPC intercept 340 for intercepting the local access attempt 332 and transporting the intercepted access attempt 342 to a local agent 350. The local agent 350 determines, by interrogating the IPC mechanism 334, a database instruction 352 corresponding to the local access attempts 332. The local agent 350 then transmits the determined database instruction 352 to the data security device 320 for analysis and further operations by the DB monitor 324. In this manner, the data security device 320 receives all local and remote access attempts to the DB server 308 to more fully analyze, monitor, and guard against access attempts that may be undesirable. Although the above-described configuration is preferred, the agent 350 need not be local, but rather may be positioned in other locations or configurations associated with a database host or system.

In a typical DB host 304, the local client 330 may employ a variety of IPC mechanisms 334 to transmit local access attempt 332 to the DB server 308. IPC typically is not secure. Alternate configurations may employ other communication mechanisms, such as cryptographic remote method invocation.

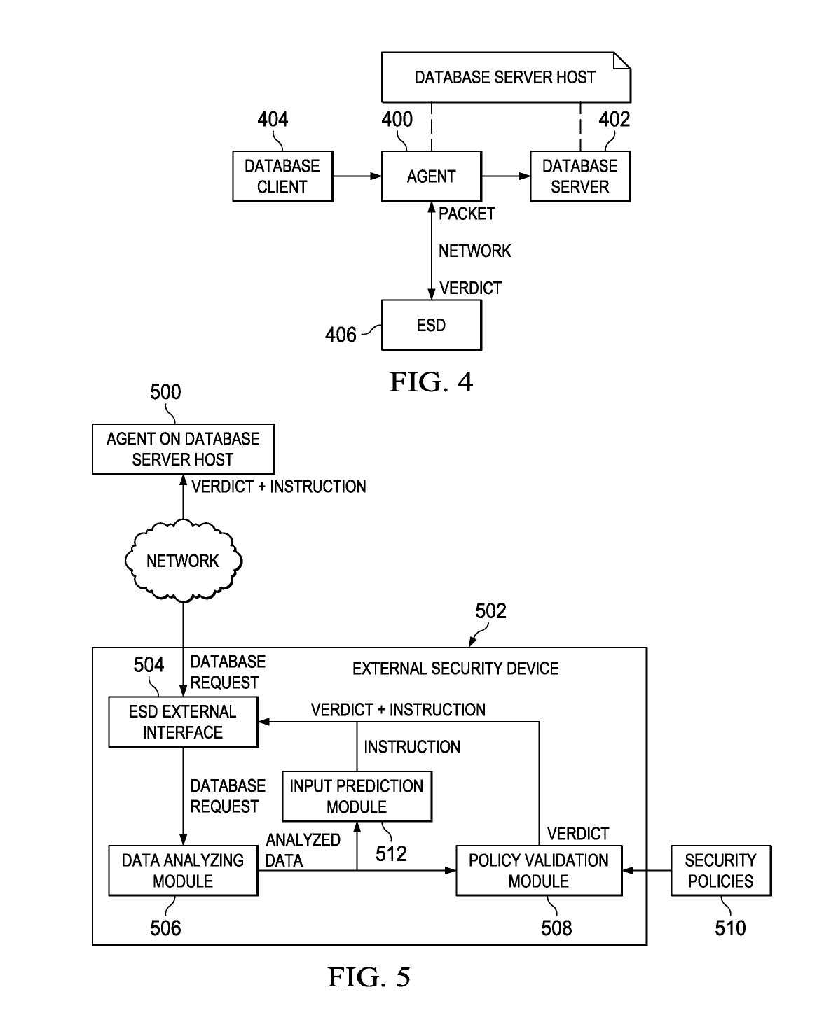

As illustrated in FIG. 4, the core of the LDACS is the lightweight agent 400 installed on the database server 402. As described above, typically the agent 400 intercepts all requests sent between a database client 404 and the database server 402. The agent is not aware of the database protocol. With reference now also to the process flow in FIG. 5, the agent holds the database client request and waits for a decision (the verdict) from the ESD. This is step 502. In particular, the agent forwards each intercepted request through the network and to the ESD 406 for further analysis. This is step 504. For each request received, the external security device extracts information from the database client request about the database object that is the subject of the request. This is step 506. At step 508, the ESD validates the request against one or more security policies. A test is then performed at the ESD to determine whether a security policy is violated. This is step 510. If not, the ESD sends the verdict back to the agent (e.g., a RELEASE DATABASE REQUEST message). This is step 512, and the message means that the agent should release the database client request to the database server. Control then continues at the agent, which releases the request (that it had been holding from step 502). This is step 514. If, however, the outcome of the test at step 510 indicates a security violation, the ESD returns a different verdict (e.g., a DROP DATABASE SESSION message) at step 516. Control then continues at the agent, which interrupts the database session due to the security violation. This is step 518, and it completes the process.

The LDACS of FIG. 3 provides significant advantages in that it can block secure and non-secure database access. It can also block local and network database traffic. The solution is database-independent, and it provides the capability to protect different database types installed on the same database host. It is also compact and uses limited resources on the database server host. While these advantages are quite desirable, the LDACS scheme has certain inefficiencies that are addressed by this disclosure. In particular, an important requirement for such a scheme is to minimize the time during which the agent holds the database client request waiting for the ESD verdict. The hold time, tₕ, can be roughly calculated as a sum of three (3) distinct times: tₙ₁—the travel time for the request to go from the agent to the ESD; tₐ—the time needed for request processing by the ESD; and tₙ₂—the travel time for the verdict to go from the ESD back to the agent. This hold time [(tₙ₁+tₐ+tₙ₂)] is associated with every packet sent to the ESD from the agent and can result in considerable slowdown of the database client application. Indeed, in the case of relatively high rate database traffic, this extensive hold time can render the LDACS scheme infeasible.

LDACS with Input Prediction

With the above serving as background, the subject matter of this disclosure is now described. The techniques herein increase LDACS throughput considerably by intelligently determining which database access requests intercepted by the agent require true ESD analysis (and thus must be sent to the ESD) and which of those requests might be predicted not to require such processing, e.g., because they do not contain (or are not expected to contain) database object information that needs to be validated against a security policy. Client requests that are predicted not to require such processing can then be passed to the database server directly without being held by the agent (and delivered to the ESD for processing). In this approach, the agent does not send every intercepted request to the ESD for evaluation against the one or more security policies. Rather, only those intercepted requests that contain database object information (or that otherwise should be validated against the one or more policies) are delivered to the ESD by the agent. Preferably, the determination about whether a particular database access request should be held or passed by the agent is made using an input prediction scheme executed at (or in association with) the ESD. In a preferred approach, and upon receipt from the agent of a request for evaluation (that will generate a verdict from the ESD), the ESD performs its usual processing but also determines (i.e. predicts) whether a next database client request (or group of requests) anticipated to be received by the agent is likely to contain (or not contain) database object information. This prediction may be based on one or more factors, such as the type of request currently being evaluated, one or more attributes of that request, one or more prior requests, other heuristics or statistics, or the like. If the ESD (in processing the current request) predicts that the next database client request (or group of requests) will include such information (and thus not need by sent to the ESD for evaluation, it returns to the agent an indication to this effect. This indication may be provided in one of many ways, e.g., as an adjunct to the verdict that is being returned in the normal manner, as a separate out-of-band communication, or the like. When the agent receives this notification, it is then applied when the next database access request(s) are then actually received (at the agent). In particular, given the ESD prediction that the next database access request(s) need not be validated against the one or more security policies, they are passed through to the database server immediately and without being held by the agent.

This operation provides for significant increases in the LDACS throughput by minimizing the number of requests that need to be evaluated, by reducing network traffic, and by enabling the ESD to operate more efficiently.

FIG. 5 illustrates the operation of an enhanced LDACS according to this disclosure. In this embodiment, agent 500 executes on in association with the database server host (not shown) and communicates over the network to the external security device 502 in the manner previously described. The ESD 502 comprises a set of components including an external interface 504, a data analyzing module 506, and a policy validation module 508. The external interface provides the I/O to and from the network. The data analyzing module receives the database request(s) (received over the interface 504) and analyzes the request(s) to identify the database object(s) and other information for analysis. The analyzed data is then passed to the policy validation module 508 for evaluation against one or more security policies 510. As a result of the evaluation, the policy validation module 508 outputs the verdict, which is then returned to the agent via the external interface 504. All of this is the conventional operation of the LDACS, as has been described.

As also illustrated in FIG. 5, the LDACS includes an input prediction module 512, which provides the enhanced functionality of this disclosure. Using the input prediction module, the ESD 502 is able to evaluate a “current” database client request (i.e., the request being currently evaluated by the ESD) to predict one or more future database client requests that may be expected to follow the current request. In particular, and according in this approach, the ESD input prediction module is aware of the various database protocol rules that govern the manner in which a database client accesses the database server. As is well-known, a database protocol is a set of message formats and rules that define communication between a database client and database server. Because of the protocol awareness, the input prediction module understands the expected requests and responses between the database client and database server for various types of interactions that are expected to occur with respect to the database. As such, the input prediction module can analyze a particular database client request, apply its protocol awareness, and then reach a determination regarding whether one or more of the next database client requests will need to be analyzed for policy violations. Referring back to FIG. 5, and based on this analysis, the input prediction module may output an “instruction,” which instruction can then be associated with the verdict (output from the policy validation module 508) and returned to the agent (via the external interface 504). The agent, upon receipt of the verdict and the instruction, then applies them as follows. The verdict is applied to the current client request, which, to that point, was being held by the agent awaiting the outcome of the processing by the ESD. As noted above, applying the verdict means that the agent either releases the current request to the database server, or interrupts the database session. The instruction is applied by the agent when the one or more next client requests are received by the agent. Typically, the instruction controls the agent to pass the one or more next client requests (as identified in the instruction) on to the database server without being held by the agent and delivered to the ESD for processing, as the existence of the instruction typically means that the input prediction module has determined that those next client requests do not need to be processed by the policy validation module.

The format of the instruction may be varied and typically will depend on the database protocol. In one embodiment, the instruction is just a flag associated with the verdict that instructs the agent to pass the next client request to the database server. Or, the instruction may include additional data that instructs the agent more explicitly, such as “pass the next n number of client requests” where n is the predicted number of client requests that will not require ESD processing. The instruction may also identify a condition that, if met (as determined by the agent), instructs the agent to pass the next client request to the database server while bypassing the ESD processing. More generally, the “instruction” is a “control command” issued by the ESD input prediction module, as it controls the agent to pass the one or more next client requests.

In a representative operation, the input prediction module 512 in the ESD determines that one or more of the next database client requests predicted to be received but that will not need to be validated against any security policies. The reasons for this determination may be varied but, in the typical case, this determination is made because the one or more next client requests are not predicted to include “database object” information. A database object in a relational database is a data structure used to either store or reference data. Examples of database objects are database tables, store procedures, triggers, indexes, views, and the like. According to this disclosure, the input prediction module uses its protocol awareness, evaluates the current request, and determines that one or more of the next client requests that are anticipated to be received by the agent will not include information about database object access that must be validated by ESD. As such, those one or more next client requests can be passed by the agent directly to the database server, effectively bypassing the ESD.

Thus, the input prediction module exploits the fact that not all message formats contain information that will be validated by ESD. As noted above, which message formats will need to be validated typically depends on the database protocol and, optionally, one or more ESD security rules (as set forth in a security policy). According to this disclosure, the input prediction module acts upon the protocol rules, or a combination of the protocol rules and information derived from one or more security policies. The result is a prediction of the sequence of one or more anticipated messages that are not needed for validation. The instruction is then generated to identify (for the agent) this sequence of one or more messages. The agent then applies the instruction against those one or more messages, as previously described.

Although the input prediction module 512 is shown as a component of the ESD, this is not a requirement, as the input prediction module may be a function implemented externally to the ESD. When the input prediction module 512 is included in the ESD, its function may be part of the data analyzing module 506 or the policy validation module 508. Thus, the representation shown in FIG. 5 should be considered a logical (or functional) representation, and it should be taken to limit the disclosed subject matter to any particular implementation.

The protocol awareness may be built into the input prediction module, or the module may obtain the database protocol rules information from an external source as needed (e.g., via a request-response protocol). Thus, an input prediction module may be customized to a particular database protocol, or it may be generic to more than one such protocol.

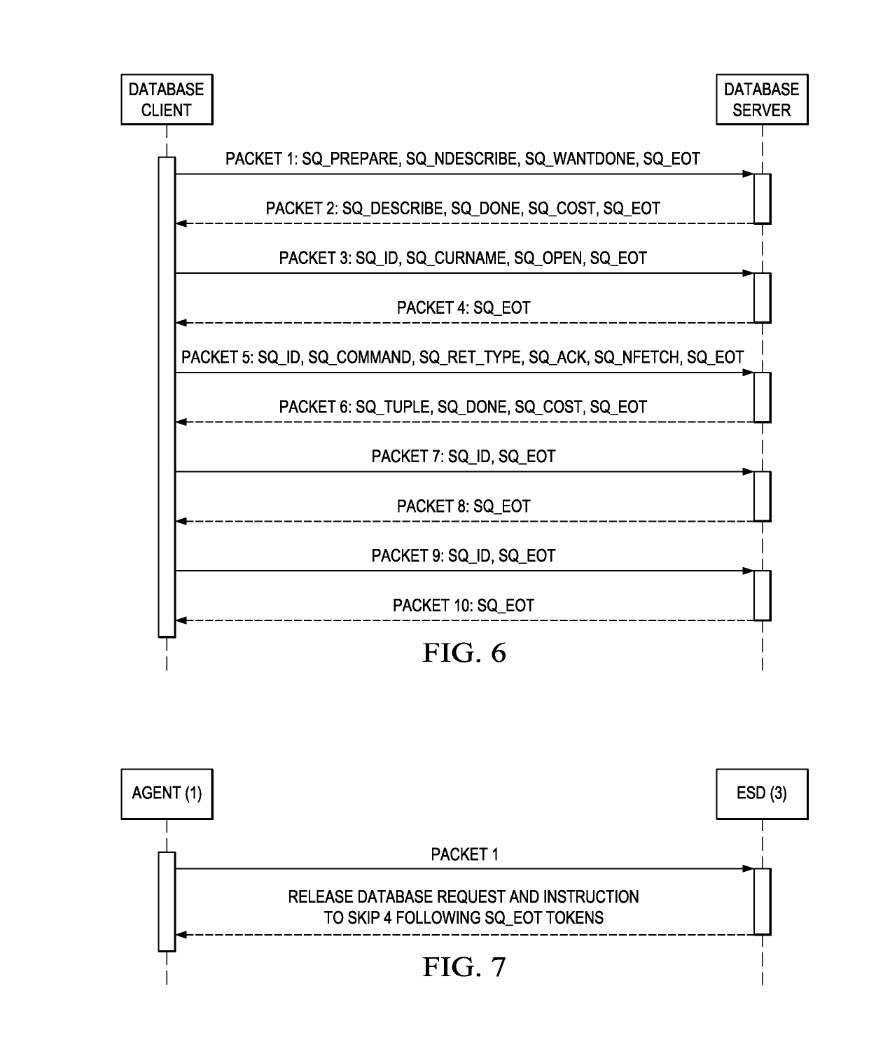

This operation can be seen by example. FIG. 6 illustrates a conventional database client-server interaction for the Informix database protocol. This example is for illustration purposes and is not intended to limit this disclosure. In this example, the data exchange includes five (5) packets (numbered 1, 3, 5, 7 and 9) corresponding to client requests, and five (5) server responses (corresponding to packets number 2, 4, 6, 8 and 10). Of the five (5) client requests, only the first one (packet 1) contains the database object name. This request, thus, will need to be validated by ESD. According to this disclosure, and as has been described, the input prediction module is protocol-aware and thus knows that, although client request (packet 1) contains the database object name, the next four (4) client requests (corresponding to packets 3, 5, 7 and 9) are not related to any LDACS security policy (and thus need not be run through ESD). Thus, the input prediction module, upon verification of the first client request, provides the agent the verdict plus an instruction to skip the next four (4) client requests. This operation results in the much more streamlined interaction between the agent and ESD shown in FIG. 7. As can be seen, implementation of the input prediction module obviates four (4) roundtrip interactions between the agent and the ESD (for processing of client requests 3, 5, 7 and 9) that would otherwise have been necessary. The resulting increase in LDACS throughput is significant. In particular, in this example, the LDACS operates approximately five (5) times faster than using the conventional agent-ESD processing.

The subject matter herein provides numerous advantages. The approach increases the throughput of the LDACS significantly, all without requiring additional database server host resources for the agent. The approach reduces network traffic, thereby increasing the efficiency of the overall policy validation. The approach also does not require the agent to be aware about the database protocol, thereby enabling the agent to be fully database independent and driven only by commands from the ESD. While there are slightly greater computational requirements at the ESD, this does not impact the efficiency of the overall solution, as typically the ESD is an external device that can operated without impacting database efficiency. Also, using a module approach, one or more input prediction modules may be easily implemented in the ESD (or in association therewith) depending on the protocol requirements. When the protocol is changed or updated, the input prediction module may be modified accordingly, transparently to the agent or other ESD functionality.

Generalizing, the input prediction (or an ESD exhibiting input prediction) functionality described above may be implemented as a standalone approach, e.g., a software-based function executed by a processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed invention are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. As noted, the techniques herein may be practiced in a loosely-coupled server (including a “cloud”-based) environment. The security server itself (or functions thereof, such as the monitor process) may be hosted in the cloud.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the analytics engine functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the ESD components are implemented in a special purpose computer, preferably in software executed by one or more processors. The software is maintained in one or more data stores or memories associated with the one or more processors, and the software may be implemented as one or more computer programs. Collectively, this special-purpose hardware and software comprises the ESD described above.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

The techniques disclosed herein are not limited to a multi-component transaction processing environment, but this will be a typical implementation. As noted, the above-described function may be used in any system, device, portal, site, or the like wherein server-set session management data might be re-used (either by an original user in a different session, or by another user) through the same client browser.

The input prediction technique described herein is not limited for use with any particular database access protocol, and it may be applied in other database access schemes generally. Thus, while LDACS is a preferred operating environment, the approach may be implemented in any database access scheme wherein database client requests are processed for potential security violations in the manner described.

Having described my invention, what I now claim is as follows.

1. A method operative in a database access control system wherein database client requests directed to a database server are intercepted by an agent for validation against a security policy, comprising:
receiving a client request that has been forwarded by the agent for validation;
determining, based on the client request and at least one database protocol rule, and using an input prediction module executed on a hardware element, whether a next client request expected to be received by the agent requires validation against a security policy;
based on an outcome of the determination, providing an instruction to the agent, wherein the instruction instructs the agent to release the next client request to the database server without forwarding the next client request for validation against the security policy.

2. The method as described in claim 1 further including:
analyzing the client request against the security policy to determine whether the client request should be passed to the database server;
generating a verdict based on the analysis; and
providing the verdict to the agent.

3. The method as described in claim 2 wherein the instruction is associated with the verdict.

4. The method as described in claim 1 wherein the determination is also based on at least one rule associated with the security policy.

5. The method as described in claim 1 whether the next client request requires validation against the security policy if the next client request is predicted by the input prediction module to include database object information.

6. The method as described in claim 1 wherein the instruction identifies one or more next client requests that should be passed to the database server without forwarding for validation against the security policy.

7. The method as described in claim 1 wherein the input prediction module is associated with one or more distinct database protocols.

8. Apparatus for use in a database access control system wherein database client requests directed to a database server are intercepted by an agent for validation against a security policy, comprising:
a processor;
computer memory holding computer program instructions that when executed by the processor perform a method, the method comprising:
receiving a client request that has been forwarded by the agent for validation;
determining, based on the client request and at least one database protocol rule, and using an input prediction module, whether a next client request expected to be received by the agent requires validation against a security policy;
based on an outcome of the determination, providing an instruction to the agent, wherein the instruction instructs the agent to release the next client request to the database server without forwarding the next client request for validation against the security policy.

9. The apparatus as described in claim 8 wherein the method further includes:
analyzing the client request against the security policy to determine whether the client request should be passed to the database server;
generating a verdict based on the analysis; and
providing the verdict to the agent.

10. The apparatus as described in claim 9 wherein the instruction is associated with the verdict.

11. The apparatus as described in claim 8 wherein the determination is also based on at least one rule associated with the security policy.

12. The apparatus as described in claim 8 whether the next client request requires validation against the security policy if the next client request is predicted by the input prediction module to include database object information.

13. The apparatus as described in claim 8 wherein the instruction identifies one or more next client requests that should be passed to the database server without forwarding for validation against the security policy.

14. The apparatus as described in claim 8 wherein the input prediction module is associated with one or more distinct database protocols.

15. A computer program product in a non-transitory computer readable medium, the computer program product holding computer program instructions which, when executed by a processor, perform a method operative in a database access control system wherein database client requests directed to a database server are intercepted by an agent for validation against a security policy, the method comprising:
receiving a client request that has been forwarded by the agent for validation;
determining, based on the client request and at least one database protocol rule, and using an input prediction module, whether a next client request expected to be received by the agent requires validation against a security policy;
based on an outcome of the determination, providing an instruction to the agent, wherein the instruction instructs the agent to release the next client request to the database server without forwarding the next client request for validation against the security policy.

16. The computer program product as described in claim 15 wherein the method further includes:
analyzing the client request against the security policy to determine whether the client request should be passed to the database server;
generating a verdict based on the analysis; and
providing the verdict to the agent.

17. The computer program product as described in claim 16 wherein the instruction is associated with the verdict.

18. The computer program product as described in claim 15 wherein the determination is also based on at least one rule associated with the security policy.

19. The computer program product as described in claim 15 whether the next client request requires validation against the security policy if the next client request is predicted by the input prediction module to include database object information.

20. The computer program product as described in claim 15 wherein the instruction identifies one or more next client requests that should be passed to the database server without forwarding for validation against the security policy.

21. The computer program product as described in claim 15 wherein the input prediction module is associated with one or more distinct database protocols.
